(19) United States
(12) Patent Application Publication
(10) Pub. No.: US 2012/0182137 A1
(43) Pub. Date: Jul. 19, 2012

(54) VEHICLE WARNING APPARATUS

(75) Inventors: Toshiaki NAKAYAMA, Miyoshi-city (JP); Kouji Sakurai, Chita-gun (JP); Koji Suzuki, Kosai-city (JP)

(73) Assignees: HAMANAKODENSO CO., LTD., Kosai-city (JP); DENSO CORPORATION, Kariya-city (JP)

(21) Appl. No.: 13/343,919

(22) Filed: Jan. 5, 2012

(30) Foreign Application Priority Data
Jan. 18, 2011 (JP) 2011-8192

(51) Int. Cl. B60Q 5/00

(52) U.S. Cl. 340/425.5

(57) ABSTRACT

A vehicle warning apparatus may include a supersonic speaker for outputting a supersonic wave that is equipped in a parametric speaker. The supersonic speaker includes a supersonic vibrator that generates a supersonic wave. A waterproof sheet and louver is arranged to cover a speaker opening in order to protect the supersonic vibrator from water and other foreign particles. Specifically, the waterproof sheet is arranged to cover the speaker opening at a distance L1 from the supersonic vibrator, where L1=L0×n/4±1/4. The louver is disposed on the other side of the waterproof sheet, such that the waterproof sheet is between the louver and the supersonic vibrator. The distance between the louver and the waterproof sheet is L2, where L2=L0×n/4±1/4. For both L1 and L2, L0 is the wavelength of the supersonic wave, and n is an odd number.

### CROSS REFERENCE TO RELATED APPLICATION

The present application is based on and claims the benefit of priority of Japanese Patent Application No. 2011-8192, filed on Jan. 18, 2011, the disclosure of which is incorporated herein by reference.

### TECHNICAL FIELD

The present disclosure generally relates to a vehicle warning apparatus that generates a warning sound for warning a pedestrian and the like around the vehicle about the approach of the vehicle.

### BACKGROUND

A warning device that outputs a sound to notify others in the vicinity of the traveling vehicle is disclosed in Japanese Patent Laid-Open No. 2005-289175 (JP '175). The vehicle warning apparatus of JP '175 generates a warning sound from a dynamic speaker.

A vehicle warning apparatus may use a different type of speaker that provides a strong directivity to generate a warning sound. In order to effectively emit a warning sound in a particular direction, the speaker of the vehicle warning apparatus may be affixed to the vehicle in a certain position that makes the speaker susceptible to water, debris, or other foreign particles that may affect the performance of or damage the speaker.

### SUMMARY

In view of the above and other problems, the present disclosure provides a vehicle warning apparatus that prevents the decrease of the sound pressure level of the supersonic wave as well as securing the waterproof structure of the supersonic vibrator in the supersonic speaker.

In an aspect of the present disclosure, a vehicle warning apparatus, which notifies the presence of a vehicle by outputting a warning sound, includes a parametric speaker and a supersonic speaker. The parametric speaker outputs a supersonic wave by performing a supersonic modulation on the warning sound. The supersonic speaker, which is equipped in the parametric speaker, includes a supersonic vibrator that generates the supersonic wave, a speaker opening from which the supersonic wave is emitted from, and a waterproof sheet that prevents water from entering the supersonic speaker.

The waterproof sheet has a supersonic wave transmitting characteristics and is configured to cover the speaker opening at a distance L1 from the supersonic vibrator. The distance L1 between the vibrator and the waterproof sheet is set to have the following value based on a wavelength L0 of the supersonic wave that is generated by the supersonic vibrator, and where “n” is defined as an odd number:

L1=L0×n/4±1/4.

In such manner, against the original wave from the supersonic vibrator, the reflected wave that is reflected back toward the supersonic vibrator by the waterproof sheet is set to have the same phase, thereby not resulting in a cancellation of the original supersonic wave by the reflected supersonic wave.

In addition to the above configuration, the vehicle warning apparatus includes a louver that is configured to have a plurality of narrow shape boards that are arranged in parallel with a gap interposed therebetween. The louver may be disposed on the other side of the waterproof sheet, such that the waterproof sheet is between the louver and the supersonic vibrator. A distance L2 between the waterproof sheet and the louver is set to have the following value based on the wavelength L0 of the supersonic wave, and where “n” is defined as an odd number:

L2=L0×n/4±1/4.

In such manner, against the original wave passing through the waterproof sheet from the supersonic vibrator, the reflected wave that is reflected back toward the waterproof sheet by the edge of the narrow board of the louver is set to have the same phase, thereby not resulting in a cancellation of the original supersonic wave by the reflected supersonic wave.

### BRIEF DESCRIPTION OF THE DRAWINGS

Objects, features, and advantages of the present disclosure will become more apparent from the following detailed description made with reference to the accompanying drawings, in which:

FIG. 1 is an illustration of vehicle warning apparatus with a first embodiment of the present disclosure;

FIG. 2A is a cross-sectional view of the vehicle warning apparatus in the first embodiment of the present disclosure;

FIG. 2B is a perspective view of the vehicle warning apparatus in the first embodiment of the present disclosure;

FIG. 3 is a diagram of a frequency characteristic of a vehicular horn of the vehicle warning apparatus in the first embodiment of the present disclosure;

FIGS. 4A and 4B are illustrations of outreach distribution of a warning sound in the first embodiment of the present disclosure;

FIG. 5 is a schematic of the vehicle warning apparatus in the first embodiment of the present disclosure;

FIGS. 6A, 6B, 6C, 6D, and 6E are illustrations of an operation principle of a parametric speaker of the vehicle warning apparatus in the first embodiment of the present disclosure;

FIG. 7 is a diagram of a sound pressure change according to a distance L1 in the first embodiment of the present disclosure;

FIGS. 8A and 8B is an illustration of a supersonic wave emitted from the vehicle warning apparatus of the present disclosure;

FIG. 9 is a diagram of a sound pressure change according to a distance L2 in the first embodiment of the present disclosure;

FIG. 10 is an illustration of a drain hole in the first embodiment of the present disclosure; and

FIG. 11 is an illustration of a drain hole in a second embodiment of the present disclosure.

### DETAILED DESCRIPTION

With reference to the drawing, embodiments of the present disclosure are explained.

In the following examples, like parts have like numbers. It is to be noted that the following examples do not limit the present disclosure only to themselves.

### First Embodiment

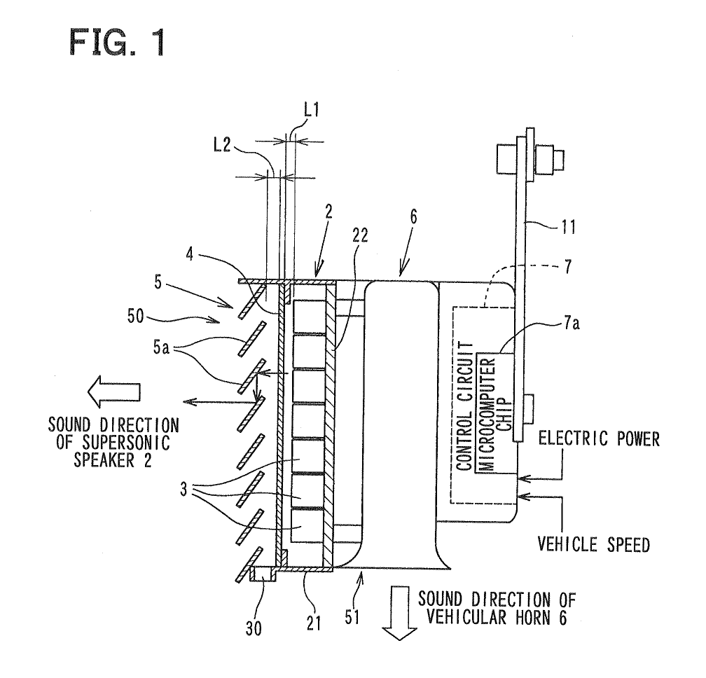

The first embodiment is explained with reference to FIGS. 1 to 10.

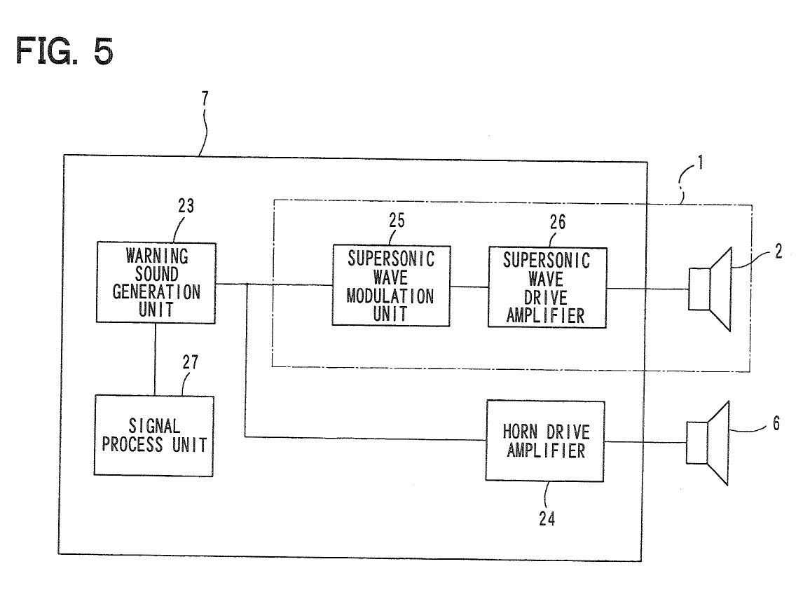

A vehicle in the present embodiment is a quiet vehicle that generates little to no sound when the vehicle is traveling, such as an electric vehicle, hybrid vehicle, or the like. The vehicle is equipped with a vehicle warning apparatus to notify the surrounding area of the presence and approach of the vehicle by way of a parametric speaker 1 (FIG. 5) that outputs a supersonic wave and a vehicular horn 6 that is operated as a dynamic speaker.

With reference to FIG. 1, the vehicle warning apparatus is equipped with the vehicular horn 6, a supersonic speaker 2, and a control circuit 7. The vehicular horn 6 may be an electro-magnetic type horn capable of generating a sound that is emitted outwards from the vehicle. The supersonic speaker 2 is capable of emitting a supersonic wave that radiates outwards from the vehicle. The control circuit 7 is configured to control the operation of the vehicular horn 6 and the supersonic speaker 2.

(Vehicular Horn 6)

The vehicle, which is equipped with vehicular horn 6, includes a horn switch or button (not shown), which is operated by a user of the vehicle in order to actuate the vehicular horn 6. The vehicular horn 6 may be installed in a front part of the vehicle. Once, the horn switch is engaged, the vehicular horn 6 generates an alarm sound or an excitation horn sound when a self-excitation voltage is above a threshold voltage, such as 8V or more.

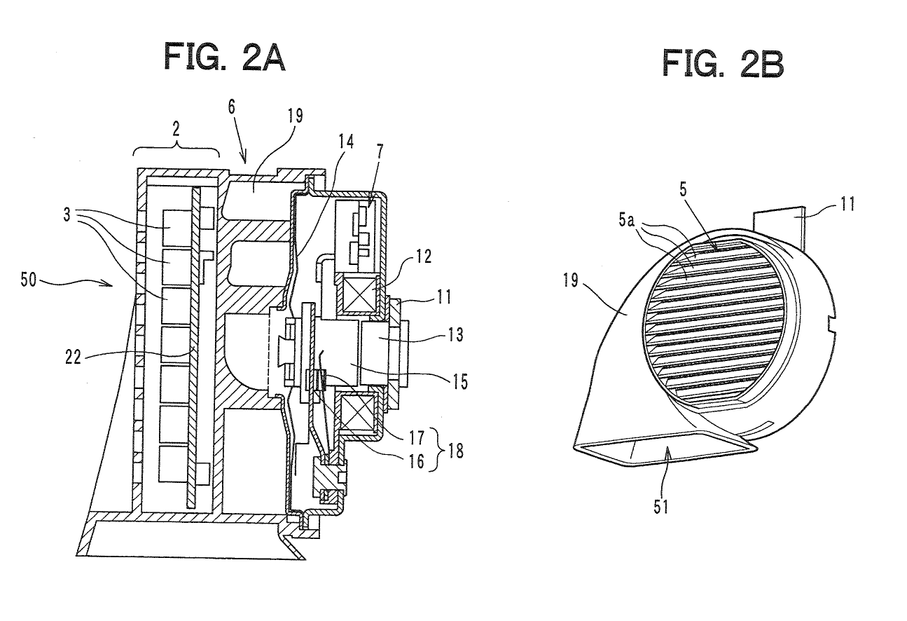

With reference now to FIGS. 2A and 2B, the vehicular horn 6 is installed with a stay 11 in a front part of the vehicle, such as in front of a radiator (not shown). The vehicular horn 6 includes a coil 12 to generate a magnetic force, a fixed iron core 13, a movable iron core 15, and a movable contact point 17. The fixed iron core 13 outputs an attraction force that is generated as a magnetic force from the coil 12, may be referred to as a magnetic attraction core.

The movable iron core 15 is supported at the center of a vibration board 14 or a diaphragm. The attraction force provided by the fixed core 13, moves the movable iron core 15 towards the fixed iron core 13, and, as a result, the movable contact point 17 decouples from a fixed contact point 16, which interrupts the electric current supplied to the coil 12.

In particular, the self-excitation voltage is supplied across the coil 12 via power terminals that are coupled to the ends of the coil 12, and a current flows across the coil 12. When the self-excitation voltage is above a threshold (i.e., the voltage is equal to or greater than 8 V), an attracting action and a returning action is repeatedly performed within the vehicular horn 6.

Specifically, in regards to the attracting action, when the current flows through the coil 12, an electromagnetic field is generated and an attraction occurs between the movable iron core 15 and the fixed iron core 13, such that the movable iron core 15 moves towards the fixed iron core 13. Due to the movement of the movable iron core 15 towards the fixed iron core 13, the moveable contact point 17, decouples from the fixed contact point 16, causing the current to stop flowing through the coil 12.

Once, the current has stopped flowing through the coil 12, the electromagnetic field is no longer generated and the moveable iron core 15 returns to its initial position, which is the returning action. Due to the biasing of the movable iron core 15, the movable contact point 17 couples with the fixed contact point 16, and the current resumes flowing through the coil 12, thus restarting the attracting action.

In other words, when the self-excitation voltage is equal to or greater than the threshold voltage the current flows through the coil 12, and an electric current interrupter 18, which allows and prevents the current from flowing through the coil 12, is formed by the fixed contact point 16 and the movable contact point 17.

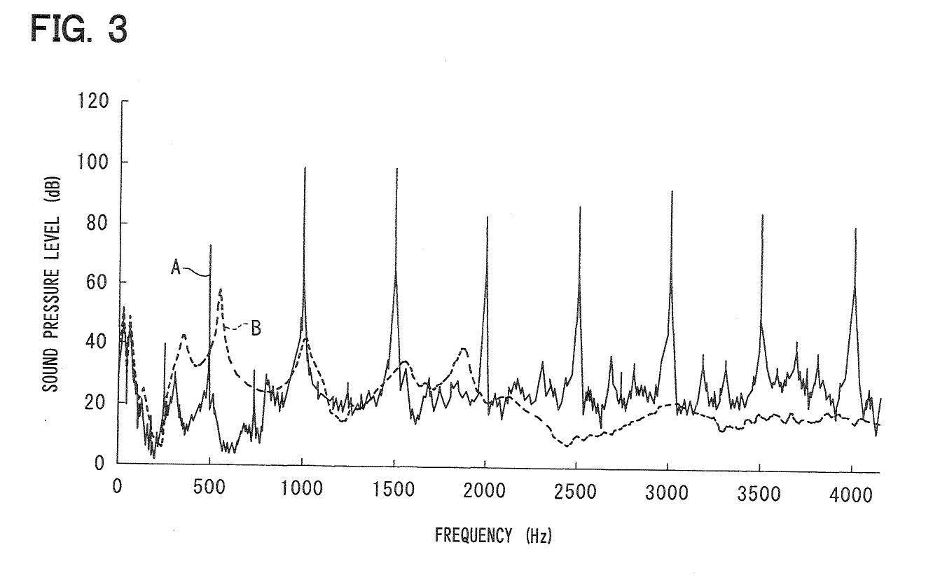

Due to the attracting and returning action, the movable iron core 15 causes a vibration of the vibration board 14, and the vehicular horn 6 generates an excitation horn sound. The vehicular horn 6 generates the excitation horn sound having predetermined frequencies (for example, 500 Hz and the like), one of which serves as a base sound. The frequency characteristics of the excitation horn sound generated when the self-excitation voltage is greater than or equal 8V by the vehicular horn 3 is shown by a solid line A in FIG. 3.

Further, in the present embodiment, the vehicular horn 6 is used as a dynamic speaker by providing a driving signal of an excitation voltage that is lower than the threshold voltage for the vehicular horn 6, such as an excitation voltage lower than 8 V).

The frequency characteristics of the vehicular horn 6 at a time of using the vehicular horn 6 as a dynamic speaker are shown by a dashed line B in FIG. 3. The dashed line B shows the frequency characteristics when a sweep signal (i.e., a variable signal transiting from a low frequency to a high frequency) of 1 V in a sine wave form is provided for the vehicular horn 6.

The vehicular horn 6 in the present embodiment includes a swirl shape horn 19 (i.e., a trumpet member in a swirling shape: a sound tube in a swirl shape) as shown in FIG. 2B. The swirl shape horn 19 amplifies the sound generated by the vibration of the vibration board 14, and radiates the amplified sound outward from the vehicle to the surrounding area. It would be apparent to one skilled in the art that the vehicular horn 6 is not required to have the swirl shape horn 19.

(Supersonic Speaker 2)

The supersonic speaker 2, as shown in FIGS. 2A and 2B, is disposed on a side face of the swirl shape horn 19 in the present embodiment, and is configured to emit a supersonic wave that radiates outward from the vehicle, such that the direction of the supersonic wave is projected in a frontal direction of the vehicle. The supersonic speaker 2 is disposed on a front facing side of the horn 19 directed towards the surrounding area of the vehicle.

The supersonic speaker 2 is a supersonic wave generator generating air vibration having a frequency that is higher than the human audible range (i.e., greater than 20 kHz).

The supersonic speaker 2 in the present embodiment includes a supersonic speaker housing 21 made of resin and disposed on a side of the swirl shape horn 19 and a plurality of piezoelectric speakers 3 that are accommodated in the supersonic speaker housing 21 (FIGS. 1, 2A, and 2B) The piezoelectric speakers may be referred to as supersonic vibrators.

Each of the piezoelectric speakers 3 is disposed on a support board 22 in the supersonic speaker housing 21, and the piezoelectric speakers 3 disposed on the same plane form a speaker array. Further, the piezoelectric speakers 3 have a well-known non-waterproof structure, and include the piezoelectric elements that expand and contract according to the applied voltage (i.e., the voltage from charge and discharge). The vibration board produces air vibration by the expansion and contraction of the piezoelectric elements.

The supersonic speaker housing 21 defines a speaker opening 50 from which a supersonic wave produced by the piezoelectric speakers 3 is emitted from. The direction of the supersonic wave may be based on the direction of the speaker opening 50, such that if the speaker opening 50 is on a front portion of the vehicle, the supersonic waves radiate outward from the front of the vehicle. It should be understood to one skilled in the art that the supersonic speaker can be located on a different portion of the vehicle, such as the rear, such that the supersonic wave radiates outwards behind the vehicle. It should also be understood to one skilled in the art that the supersonic waves can be redirected with the use of reflectors or the like, such that the direction the supersonic waves are not completely dependent upon on the location of the supersonic speaker 2 on the vehicle. For example, if the speaker opening 50 is towards a front part of the vehicle, reflectors can be used such that the supersonic waves radiate outward as if coming from a side of the vehicle or even the back of the vehicle.

The speaker opening 50 is equipped with a waterproof unit to prevent invasion of water into the supersonic speaker. The details regarding the waterproof unit is described later.

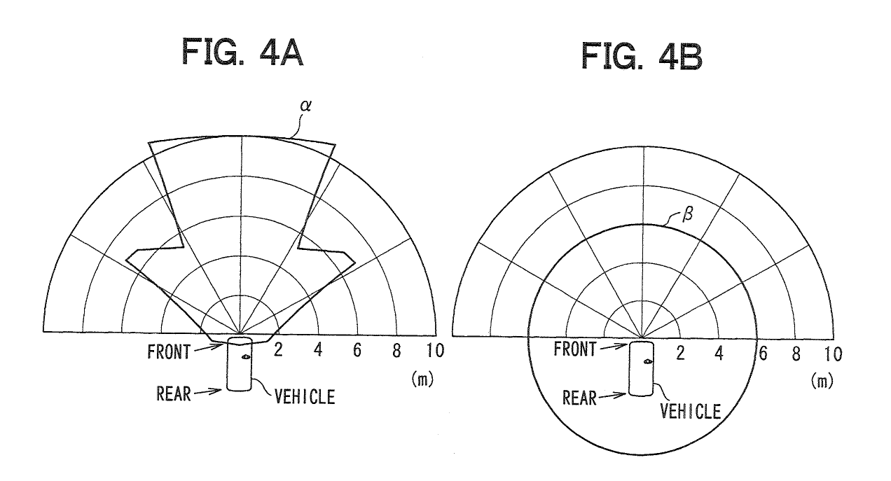

FIG. 4A illustrates a coverage area α of the warning sound from the parametric speaker 1 and FIG. 4B illustrates a coverage area β of the warning sound from the vehicular horn 6. As described above, the supersonic speaker 2 of the present embodiment is disposed to emit a supersonic wave outward toward a frontal direction of the vehicle.

Further, the vehicular horn 6 is arranged to emit the warning sound substantially evenly around the vehicular horn 6, as shown in FIG. 4B. A horn opening 51 of the swirl shape horn 19 in the vehicular horn 6, from which the warning sound is emitted, is directed in a downward direction of the vehicle to face the road surface. The direction of the horn opening 51 may also be set in a different direction, and the supersonic wave from the horn opening 51 in such direction may be reflected by a reflector or the like to be redirected in another direction, including a downward direction of the vehicle.

(Control Circuit 7)

A control circuit 7 includes a microcomputer chip 7a disposed on a control substrate as shown in FIG. 1. The control circuit 7 is disposed in the vehicular horn 6.

The control circuit 7 includes, as shown in FIG. 5,

(a) a warning sound generation unit 23 for generating a warning sound signal,

(b) a horn drive amplifier 24 for driving the vehicular horn 6 according to the warning sound signal,

(c) a supersonic wave modulation unit 25 for modulating the warning sound signal into a signal having the supersonic frequency,

(d) a supersonic wave drive amplifier 26 for driving the supersonic speaker 2 according to the supersonic modulated signal, and

(e) a signal process unit 27 for controlling the above-described operations.

The above-described elements of the control circuit 7 are explained in the following.

(Warning Sound Generation Unit 23)

The warning sound generation unit 23 generates a pre-stored warning sound signal (i.e., a signal having audible frequency), such as a simulated engine sound, a single sound, a chord sound, or the like, according to the information provided from the signal process unit 27.

(Horn Drive Amplifier 24)

The horn drive amplifier 24 is a power amplifier that operates the vehicular horn 6 as a dynamic speaker. The horn drive amplifier 24 amplifies a warning sound signal from the warning sound generation unit 23, and outputs the amplified signal to the power terminals coupled to the coil 12 of the vehicular horn 6.

The maximum output of the horn drive amplifier 24 is restricted to 8 V or less, which is provided as the separate excitation voltage, and the voltage output from the horn drive amplifier 24 for generating the warning sound is configured to have a level that will not generate the excitation horn sound from the vehicular horn 6. In other words, when the self-excitation voltage is equal to the separate excitation voltage (i.e. it is lower than 8V), the excitation horn sound is not produced by the vehicular horn 6, but the warning sound generated by the warning sound signal is produced by the vehicular horn 6.

(Supersonic Wave Modulation Unit 25)

The supersonic wave modulation unit 25 performs a supersonic modulation to a warning sound signal from the warning sound generation unit 23.

In the present embodiment, the supersonic wave modulation unit 25 uses amplitude modulation (i.e., AM modulation) for modulating the warning sound signal into a signal of amplitude change (i.e., an increase and decrease change of the voltage) in the supersonic wave frequency (e.g., 40 kHz).

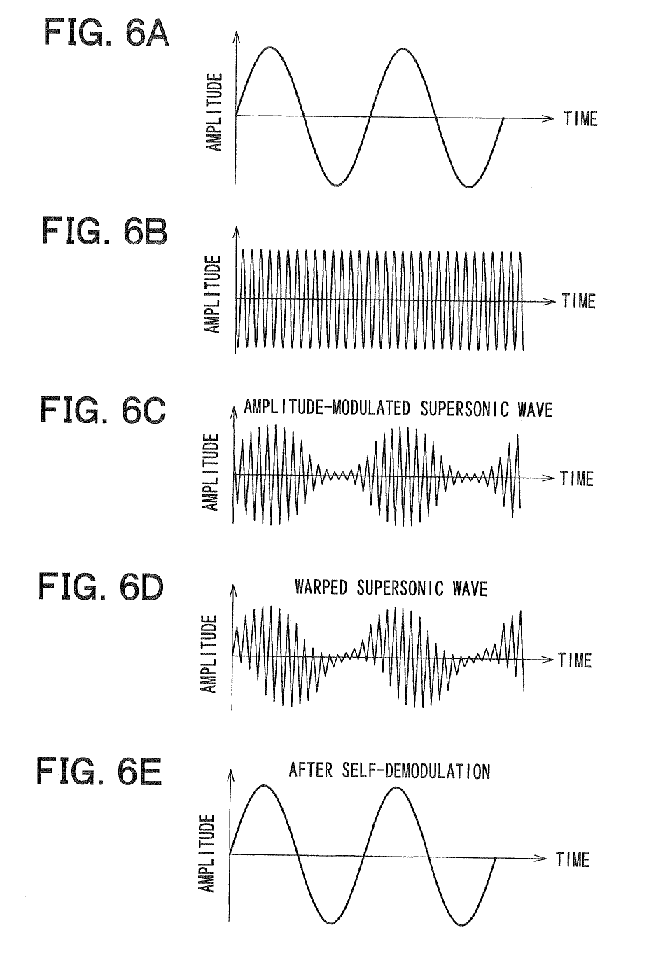

An example of the supersonic modulation by the supersonic wave modulation unit 25 is explained with reference to FIGS. 6A to 6C.

For example, the warning sound signal is provided to the supersonic wave modulation unit 25 as a voltage change having a wave form of a single frequency in FIG. 6A, which is showed for explanation purposes and should be understood that the wave form may take other forms.

A supersonic wave oscillator in the control circuit 7 oscillates at a supersonic frequency shown in FIG. 6B.

In FIG. 6C, the supersonic wave modulation unit 25 performs the following:

(i) as the signal voltage of the frequency to generate a warning sound signal increases, the supersonic wave modulation unit 25 increases the amplitude of the voltage of the supersonic wave vibration, and

(ii) as the signal voltage of the frequency to generate a warning sound signal decreases, the supersonic wave modulation unit 25 decreases the amplitude of the voltage by the supersonic wave vibration.

In the above-described manner, the supersonic wave modulation unit 25 modulates the warning sound signal output from the warning sound generation unit 23 into the amplitude change of the oscillation voltage having the supersonic wave frequency.

Further, the supersonic wave modulation unit 25 may use other modulation technique, such as pulse width modulation (PWM) that modulates a warning sound signal into a signal of width change (i.e., width of the pulse generation time) in the supersonic wave frequency.

(Supersonic Wave Drive Amplifier 26)

The supersonic wave drive amplifier 26 drives each of the piezoelectric speakers 3 based on the supersonic wave signal that is modulated by the supersonic wave modulation unit 25. That is, the supersonic wave drive amplifier 26 generates the supersonic wave, which is formed by the modulation of the warning sound signal, by controlling the applied voltage for (i.e., charging and discharging conditions of) each of the piezoelectric speakers 3.

In the present embodiment, the supersonic wave drive amplifier 26 may be a push-pull type analog amplifier (for example, a class B amplifier) that applies to each of the piezoelectric speakers 3 the increase and decrease of the voltage of the supersonic wave signal that is outputted from the supersonic wave modulation unit 25.

(Signal Process Unit 27)

The signal process unit 27 generates a warning sound when the signal process unit 27 receives a warning sound operation signal, which is an operation instruction signal, from, for example, an electronic control unit (ECU) of the vehicle.

The ECU may generate the warning sound operation signal in the following situations:

(i) The ECU generates the warning sound operation signal and provides the signal to the signal process unit 27 when the vehicle is in a certain driving condition, which requires the output of the warning sound, such as when the vehicle is traveling at a speed of 20 km/h or slower.

OR

(ii) The ECU generates the warning sound operation signal and provides the signal to the signal process unit 27 when the existence of a human being is confirmed by a human recognition system (not illustrated) in a traveling direction of the vehicle.

After receiving the warning sound operation signal from the ECU, the signal process unit 27 operates:

(i) the parametric speaker 1 to output “a warning sound” from the supersonic speaker 2, and

(ii) the vehicular horn 6 as a dynamic speaker to output the warning sound also from the vehicular horn 6.

(Operation of Vehicle Warning Apparatus)

When the warning sound operation signal is provided for the signal process unit 27 from the ECU, a supersonic wave, which is inaudible, is generated by modulating the warning sound signal. The supersonic wave (FIG. 6C) is emitted from the supersonic speaker 2 under the control of the signal process unit 27 toward a frontal direction of the vehicle.

In FIG. 6D, as the supersonic wave travels in the air, the supersonic wave having a short wave length is warped by, for example, a viscosity of the air or the like. That is, the edge of the supersonic wave dulls, due to the attenuation of the wave energy. As a result, as shown in FIG. 6E, an amplitude component in the supersonic wave is self-demodulated during the travel of the supersonic wave, thereby reproducing the warning sound. The warning sound produced by the supersonic wave is audible at a position that is distant from the vehicle.

Further, when the warning sound operation signal is provided for the signal process unit 27 from the ECU, a warning sound signal is amplified and is emitted from the vehicular horn 6 under control of the signal process unit 27. As a result, the warning sound is reproduced around the vehicle.

(Waterproof Unit)

The waterproof unit prevents water from entering the supersonic speaker 2 via the speaker opening 50. The waterproof unit prevents the water from damaging the piezoelectric speakers 3.

With reference back to FIG. 1, the waterproof unit includes a waterproof sheet 4 and a louver 5. The waterproof sheet covers the speaker opening 50, and has a supersonic wave transmitting characteristic. The louver 5 includes a plurality of narrow boards 5a, which are disposed outside of the waterproof sheet 4, such that the waterproof sheet 4 is between the louver 5 and the piezoelectric speakers 3. The narrow boards 5a are arranged in a parallel arrangement with a gap interposed therebetween. The waterproof sheet 4 and the louver 5 are disposed in front of the piezoelectric speakers 3.

The waterproof sheet 4 may entirely cover the speaker opening 50 of the supersonic speaker housing 21, and has waterproof and supersonic wave transmitting characteristics, such as breathability, for good sound effect. The waterproof sheet 4 may be in a cloth form or a membrane form that has breathability characteristics to pass air and waterproofing characteristics to prevent the water from passing.

For example, the waterproof sheet 4 may be a felt cloth, which is non-woven, and has both breathability, which is type of supersonic wave transmitting characteristic, and water-repellant characteristics. Specifically, the felt cloth may be made of water-repellant fiber felt or water-repellant processed felt, where the waterproof capacity can be determined by the thickness of the cloth, density of the cloth, or the like.

The felt cloth is one example of the waterproof sheet 4 in the present embodiment, but the waterproof sheet 4 may also be made of other sheet material, such as water-proof processed fabric cloth or goretex (a registered trademark) that have the waterproofing characteristics and the supersonic wave transmitting characteristics.

The waterproof sheet 4 is arranged in front the piezoelectric speakers 3 and is in parallel with the support board 22 on which the piezoelectric speakers 3 are disposed. (i.e., each of the supersonic vibration boards).

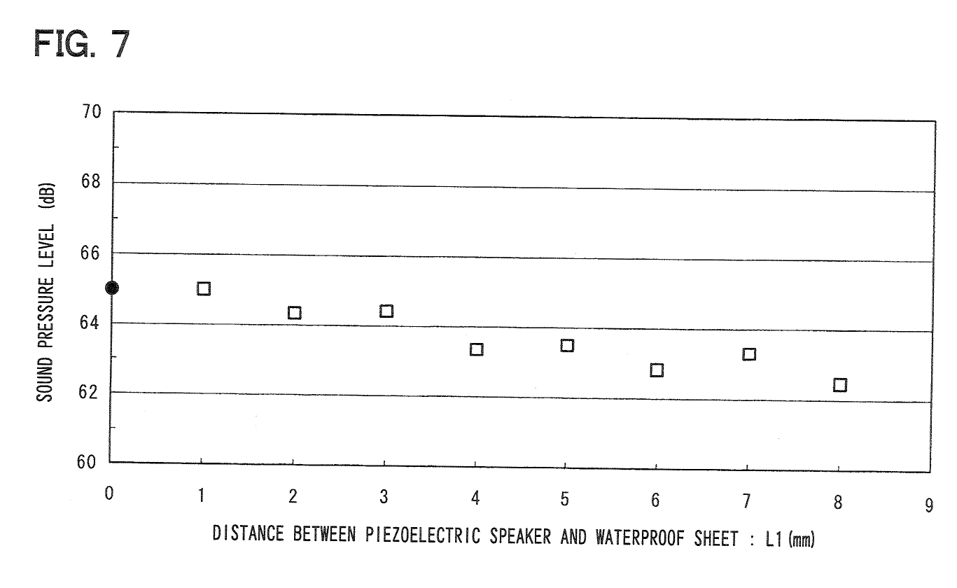

The distance between the piezoelectric speaker 3 and the waterproof sheet 4 is provided as a distance L1. With reference to FIG. 7, when a supersonic wave having a predetermined frequency and a predetermined sound pressure level is emitted from the supersonic speaker 2, the sound pressure level of the supersonic wave changes when the supersonic wave passes through the waterproof sheet 4. Specifically, depending upon the distance L1, the sound press level may increase or decrease, The sound pressure level at the distance L1=0 in FIG. 7 is a sound pressure level without having the waterproof sheet 4.

Such change of the sound pressure level described above is caused by the small amount of the supersonic wave reflected back by the waterproof sheet 4. If a wavelength of the frequency of the supersonic wave to be supersonic-modulated is defined as L0, and a distance between the piezoelectric speaker 3 and the waterproof sheet 4 is defined as L1, a value of L1 matching with an integer multiplication of L0/2, (e.g., L0×1/2), and the like, causes a problem.

Problematic distance L1=L0×n/2 (n:integer)

That is, when the original wave from the piezoelectric speaker 3 and the reflected wave that is reflected by the waterproof sheet 4 cancel each other, due to the reverse phase of the reflected wave, the sound pressure level of the supersonic wave from the supersonic speaker 2 decreases.

Therefore, the supersonic speaker 2 in the present embodiment has the distance L1 between the piezoelectric speaker 3 and the waterproof sheet 4 set to a following value based on the wavelength L0 of the supersonic wave from the piezoelectric speaker 3 to be super-modulated,

L1=L0×n/4±1/4 (n:odd number).

In such manner, the distance L1 is set to be within a distance range that allows the reflected wave reflected back toward the piezoelectric speaker 3 by the waterproof sheet 4 to have the same phase (i.e., an in-phase range) against the original wave from the piezoelectric speaker 3.

More practically, if the wavelength L0 of the supersonic frequency (e.g., 40 kHz) is to be used for supersonic modulation is about 4 mm, the distance L1 from the piezoelectric speaker 3 to the waterproof sheet 4 is provided as,

L1=4mm×n/4 (n:odd number).

That is, the value of the distance L1 may be chosen from among 1 mm, 3 mm, 5 mm, 7 mm in FIG. 7, at which the decrease of the sound pressure level is prevented.

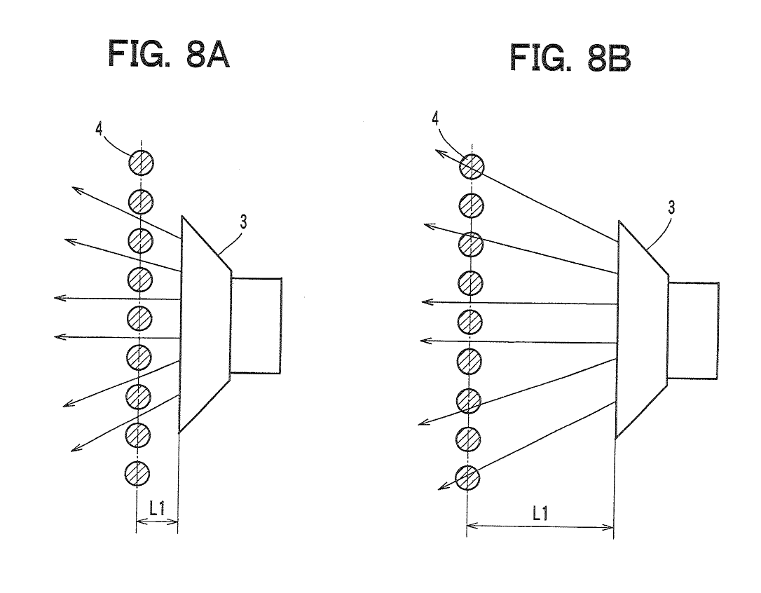

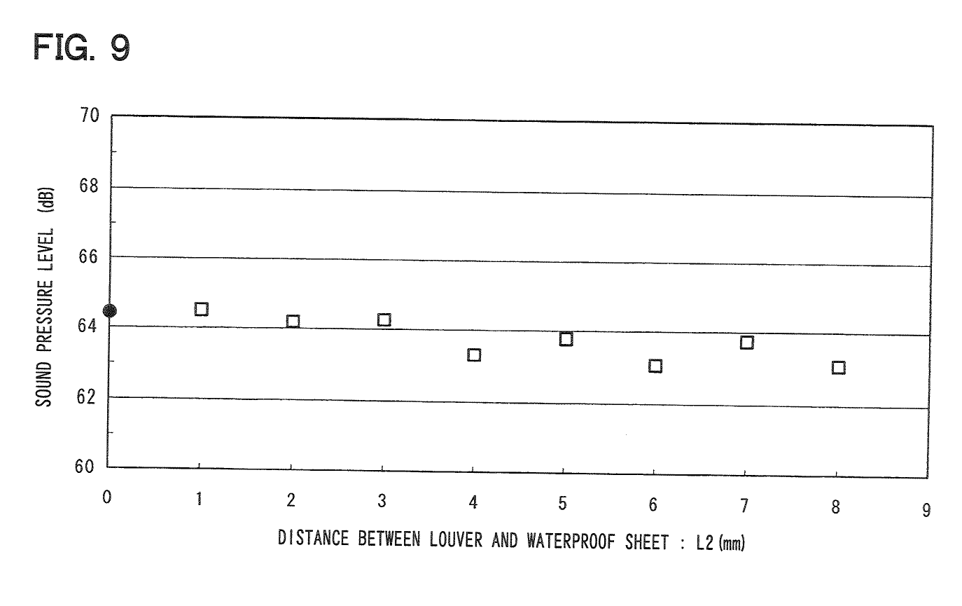

With reference to FIGS. 8A and 8B, when the distance L1 from the piezoelectric speaker 3 to the waterproof sheet 4 is short (FIG. 8A), the decrease of the sound pressure level of the supersonic wave is prevented due to the decrease of the supersonic wave diagonally passing through the waterproof sheet 4.

However, when the distance L1 from the piezoelectric speaker 3 to the waterproof sheet 4 is long (FIG. 8B), the sound pressure level of the supersonic wave is decreased due to the increase of the supersonic wave diagonally passing through the waterproof sheet 4.

Therefore, it is preferable that the distance L1 from the piezoelectric speaker 3 to the waterproof sheet 4 is short.

Air resistance or wind created during a travel of the vehicle, may warp the waterproof sheet 4 toward the piezoelectric speaker 3. Additionally, during a wet condition, such as rain, car wash, or the like, it is further desirable to prevent the waterproof sheet 4 from contacting the piezoelectric speaker 3.

Therefore, the distance L1 from the piezoelectric speaker 3 to the waterproof sheet 4 is set to have a value that prevents the waterproof sheet 4 from contacting the piezoelectric speaker 3 when the waterproof sheet 4 is in a warped stated caused by the wind pressure of the traveling vehicle. Accordingly, if the waterproof sheet 4 has a maximum warp distance of 2 mm, which is based on the speed of the vehicle, the distance L1 from the piezoelectric speaker 3 to the waterproof sheet 4 may be provided as 2 mm or more.

Based on the determination factors described above, the distance L1 from the piezoelectric speaker 3 to the waterproof sheet 4 is set to 3 mm in the present embodiment.

The vehicle warning apparatus of the present embodiment has, as described above, the distance L1 set to have the following relationship of L1=L0×n/4 (n:odd number). In such manner of having the reflected wave having the same phase (i.e., an in-phase range), a problematic decrease of the sound pressure level of the supersonic wave due to the cancellation between the original wave from the piezoelectric speaker 3 and the reflected wave from the waterproof sheet 4 is prevented.

Because the decrease of the sound pressure level by the reverse phase of the reflected wave is prevented in such manner,

(i) the consumption of electricity by the supersonic wave drive amplifier 26 is reduced, and

(ii) the number of the piezoelectric speakers 3 used in the supersonic speaker 2 is decreased, thereby improving the install-ability of the vehicle warning apparatus in the vehicle.

Further, the vehicle warning apparatus of the present embodiment has the distance L1 from the piezoelectric speaker 3 to the waterproof sheet 4 set to the minimum value in a distance range that does not allow the contact of the warped waterproof sheet 4 with the piezoelectric speaker 3 when the waterproof sheet 4 is warped by the wind pressure of the traveling vehicle.

Therefore, by having the distance L1 set to the shortest value in the allowable distance range, the supersonic wave diagonally passing through the waterproof sheet 4 is decreased, thereby preventing the decrease of the sound pressure level due to the diagonally-passing supersonic wave through the waterproof sheet 4.

Furthermore, the decrease of the sound pressure level is prevented because of the prevention of the waterproof sheet 4 to be contacting the piezoelectric speaker 3 in the wind pressure of the traveling vehicle.

Further, the waterproof sheet 4 in a wet condition due to the travel of the vehicle in the rain is prevented from contacting the piezoelectric speaker 3, thereby preventing a trouble caused by the waterproof sheet 4 in a wet condition to have a contact with the piezoelectric speaker.

The louver 5 is arranged in front of the waterproof sheet 4 for significantly reducing the amount of water that contacts the waterproof sheet 4, and is used to prevent a direct hit of the water on the waterproof sheet 4. The louver 5 is formed by the narrow boards 5a that are disposed in parallel with a gap interposed therebetween.

The louver 5 is disposed so as not to alter the straight travel of the supersonic wave from the piezoelectric speaker 3. More practically, each of the boards 5a in the louver 5 is disposed in an angle of 45 degrees against a vehicle level direction. In such manner, the supersonic wave output from each of the piezoelectric speakers 3 is reflected into a downward direction on an inside of the board 5a, and is then reflected again into a horizontal direction on an outside of the board 5a toward the front of the vehicle, to be emitted from a frontal direction of the vehicle (FIG. 1).

The louver 5 is arranged in parallel with a front face of the waterproof sheet 4. The waterproof sheet 4 and the louver 5 are separated by a distance L2. When a supersonic wave having a predetermined frequency and a predetermined sound pressure level is emitted from the supersonic speaker 2, a the sound pressure level of the supersonic wave changes after passing through the waterproof sheet 4 and the louver 5. Specifically, as shown in FIG. 9, the sound pressure level of the supersonic wave may increase or decrease, based upon the distance L2. Further, the sound pressure level at a position of the distance L2=0 in FIG. 9 is a sound pressure level without having the louver 5.

Such change of the sound pressure level described above is caused by the small amount of the supersonic wave reflected back by the edge of each louver board 5a. If a wavelength of the frequency of the supersonic wave to be supersonic-modulated is defined as L0, and a distance between the waterproof sheet 4 and the louver 5 is defined as L2, a value of L2 matching with an integer multiplication of L0/2, (e.g., L0×1/2), and the like, causes a problem.

Problematic distance L2=L0×n/2 (n:integer)

That is, when the original wave from the piezoelectric speaker 3 and the reflected wave that is reflected by the waterproof sheet 4 cancel with each other, due to the reverse phase of the reflected wave, the sound pressure level of the supersonic wave from the supersonic speaker 2 decreases.

Therefore, the supersonic speaker 2 in the present embodiment has the distance L2 between the waterproof sheet 4 and each board 5a set to a following value based on a wavelength L0 of the supersonic wave to be super-modulated,

L2=L0×n/4±1/4 (n:odd number).

In such manner, the distance L2 is set to be within a distance range that allows the reflected wave reflected by the edge of each board 5a back to the waterproof sheet 4 to have the same phase, (i.e., an in-phase range), against the original wave passing through the waterproof sheet 4.

More practically, when the wavelength L0 of the supersonic wave frequency (e.g., 40 kHz) to be super-modulated is about 4 mm, the distance L2 from the waterproof sheet 4 to each board 5a satisfies a relationship of L2=4 mm×n/4 (n:odd number). Therefore, the value of the distance L2 may be chosen from among 1 mm, 3 mm, 5 mm, 7 mm in FIG. 9, at which the decrease of the sound pressure level is prevented.

The vehicle warning apparatus of the present embodiment has, as described above, the distance L2 set to have the following relationship of L2=L0×n/4 (n:odd number). In such manner of having the reflected wave having the same phase (i.e., an in-phase range), a problematic decrease of the sound pressure level of the supersonic wave due to the cancellation between the original wave passing through the waterproof sheet 4 and the reflected wave back from the louver board 5a is prevented.

Because the decrease of the sound pressure level by the reverse phase of the reflected wave is prevented in such manner,

(i) the consumption of electricity by the supersonic wave drive amplifier 26 is reduced, and

(ii) the number of the piezoelectric speakers 3 used in the supersonic speaker 2 is decreased, thereby improving the install-ability of the vehicle warning apparatus in the vehicle.

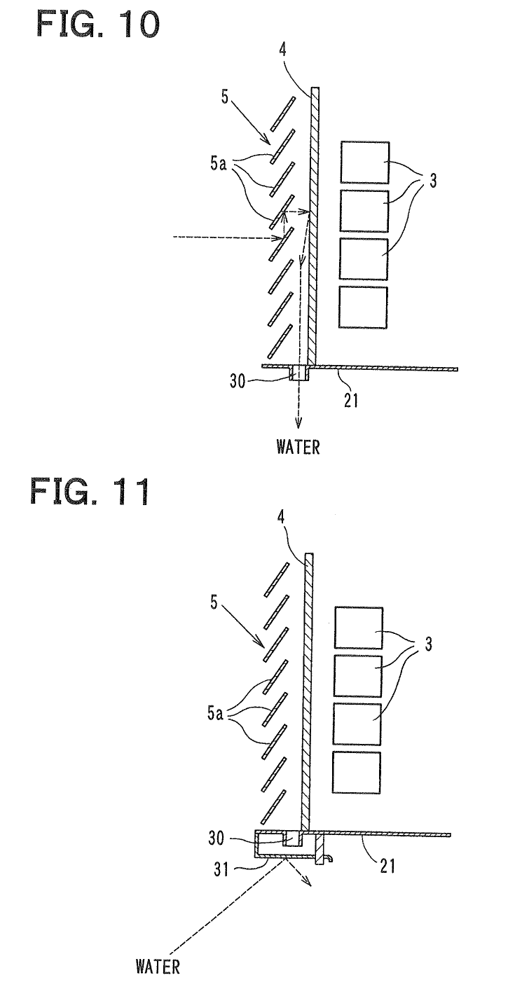

The supersonic speaker 2, in the present embodiment is equipped with a drain hole 30 on the louver 5 side of the waterproof sheet 4 at a lower portion of the supersonic speaker housing 21, as shown in FIGS. 1 and 10.

The drain hole 30 is provided as a through hole on a lower edge of the supersonic speaker housing 21, the drain hole 30 discharges the water that is led to the lower portion of the waterproof sheet 4 after being repelled off the waterproof sheet 4.

Because such drain hole 30 is provided, water is prevented from collecting at a lower part of the waterproof sheet 4, thereby preventing a problem of such pooled water that may enter the other side of the waterproof sheet 4 towards the piezoelectric speaker 3.

### Second Embodiment

The second embodiment 2 is explained with reference to FIG. 11. Like parts in the second embodiment have like numbers in the first embodiment.

In the second embodiment, a cover 31 for covering a lower end of the drain hole 30 is provided at a position under the drain hole 30, which is described in the first embodiment. The cover 31 and the lower end of the drain hole 30 are separated by a small gap.

The cover 31 is a water reflector, and is detachable from the supersonic speaker housing 21 in the present embodiment.

More practically, the supersonic speaker housing 21 has a socket for accepting the cover 31 inserted therein, and the socket has a resilient claw. The cover 31 has an engaging portion to be engaged with the claw on the socket. By the engagement of the claw with the engaging portion, the cover 31 is assembled onto the supersonic speaker housing 21.

Further, the cover 31 need not be detachable from the housing 21, and the cover 31 may be affixed on the supersonic speaker housing 21 with a a screw or the like, or the cover 31 may be integrally formed with the supersonic speaker housing 21 in one body.

In the second embodiment, the rainwater does not reach the drain hole 30 from below the drain hole 30 due to the cover 31 disposed under the drain hole 30, as shown in FIG. 11.

In such manner, the rainwater passing through the drain hole 30 to directly hit the waterproof sheet 4 is prevented, thereby preventing the invasion of the rainwater into the inside of the waterproof sheet 4 due to the direct hit of the rainwater on the waterproof sheet 4.

In an example of the above embodiment, the swirl horn 19 (i.e., a trumpet member) is used as the vehicular horn 6. However, the vehicular horn 6 may be a horn without the swirl horn 19. That is, a planar (i.e., disk shape) horn, which generates a warning sound by the vibration of the vibration board 14, may be used.

In an example of the above embodiments, the present disclosure is shown as an application to the vehicle warning apparatus which uses a dynamic speaker (i.e., the vehicular horn 6) together with the parametric speaker 1. However, the vehicle warning apparatus may generate the warning sound by using the parametric speaker 1 only, or by using the dynamic speaker (i.e., the vehicular horn 6) only.

Based on the foregoing, the vehicle warning apparatus notifies the existence of a vehicle via a warning sound, such as a single sound, a chord sound, a music piece, a voice, a simulated engine sound, and the like. The vehicle warning apparatus includes the parametric speaker 1 that outputs a supersonic wave by performing a supersonic modulation to a warning sound.

The supersonic speaker 2 in the parametric speaker 1 has the piezoelectric speaker 3 (e.g., a supersonic vibrator) that emits a supersonic wave. The waterproof sheet 4, which has a supersonic wave transmitting characteristic, covers a speaker opening 50 of the piezoelectric speaker 3 on its supersonic wave outputting side. The louver 5 is disposed on an outside of the waterproof sheet 4 as a plurality of narrow boards 5a that are in a parallel arrangement with a gap interposed therebetween.

Further, when a wavelength of the supersonic wave to be super-modulated is defined as L0, together with a distance L1 between the piezoelectric speaker 3 and the waterproof sheet 4, and a distance L2 between the waterproof sheet 4 and each of the narrow boards 5a, the following relationships are satisfied.

L1=L0×n/4±1/4 (n:odd number)

L2=L0×n/4±1/4 (n:odd number)

In this manner, (i) against the original wave from the piezoelectric speaker 3, the reflected wave that is reflected back toward the piezoelectric speaker 3 by the waterproof sheet 4 is set to have the same phase or an in-phase range, and (ii) against the original wave passing through the waterproof sheet 3 from the piezoelectric speaker 3, the reflected wave that is reflected back toward the waterproof sheet 4 by the edge of each of the boards 5a is set to have the same phase or an in-phase range.

When the decrease of the sound pressure level of the supersonic wave by the reverse phase of the reflected wave is prevented, the following advantages are achieved.

(i) The electricity consumption of the supersonic wave drive amplifier (i.e., an amplification unit to drive a supersonic vibrator) is reduced, and

(ii) The number of the supersonic vibrators used in a supersonic speaker is decreased, thereby improving the install-ability of the apparatus in the vehicle.

In addition to the above configuration, the vehicle warning apparatus is configured to have the distance L1 set to a minimum value that does not let the waterproof sheet 4 contact the piezoelectric speaker 3 (supersonic vibrator in claims) even when the waterproof sheet is deformed by a wind pressure of a traveling vehicle.

By having the distance L1 between the piezoelectric speaker 3 and the waterproof sheet 4 set to the minimum value, the amount of the supersonic wave diagonally passing through the waterproof sheet 4 is decreased, thereby preventing the decrease of the sound pressure level due to the diagonal passing of the supersonic wave through the waterproof sheet 4 diagonally.

Further, a wet condition of the waterproof sheet, such as in rainy weather or the like, does not result in a contact of the waterproof sheet with the piezoelectric speaker 3, thereby preventing a problem of wet waterproof sheet having a contact with the piezoelectric speaker 3.

In other words, even when the waterproof sheet is deformed by the wind pressure of the traveling vehicle, the waterproof sheet does not reach the piezoelectric speaker 3, thereby preventing the decrease of the sound pressure level that is caused by the waterproof sheet having a contact with the piezoelectric speaker 3.

When water collects in a lower part of the waterproof sheet 4, even if it is an outside of the waterproof sheet 4, the collected water may invade or enter into, an inside of the waterproof sheet, due to the influence of the wind pressure or the like.

Therefore, the supersonic speaker 2 of the vehicle warning apparatus has a drain hole 30 for letting out the collected water on an outside of the waterproof sheet at a lower part.

By having the drain hole 30, the water led toward a lower part of the waterproof sheet 4 is discharged through the drain hole 30, thereby not causing the water to be collected at the lower part on an outside of the sheet. As a result, invasion of the water into the inside of the waterproof sheet 4 is prevented.

In addition to the above configuration, the drain hole 30 has a cover 31 that is disposed under a lower end of the drain hole with a predetermined gap interposed therebetween.

The drain hole 30 described above may allow the water to pass through the drain hole 30 from its lower end toward the lower part of the waterproof sheet 4 when the water is bounced on the road surface or swirled by the wind of the traveling vehicle. In such case, the water may hit the waterproof sheet thereby invading the inside of the sheet.

The above described configuration of the drain hole 30 prevents the rainwater to reach the drain hole by having a cover 31, thereby preventing the rainwater to hit the waterproof sheet 4 through the drain hole 30.

Although the present disclosure has been fully described in connection with preferred embodiment thereof with reference to the accompanying drawings, it is to be noted that various changes and modifications will become apparent to those skilled in the art.

Changes, modifications, and summarized schemes are to be understood as being within the scope of the present disclosure as defined by appended claims.

What is claimed is:

1. A vehicle warning apparatus for notifying the presence of a vehicle by outputting a warning sound, the vehicle warning apparatus comprising:
a parametric speaker for outputting a supersonic wave by performing a supersonic modulation on the warning sound;
a supersonic speaker for outputting the supersonic wave, and is equipped with the parametric speaker;
the supersonic speaker includes a supersonic vibrator, a waterproof sheet, and defines a speaker opening from which the supersonic wave is emitted from;
the supersonic vibrator is configured to generate the supersonic wave,
the waterproof sheet has a supersonic wave transmitting characteristics and is configured to cover the speaker opening at a distance L1 from the supersonic vibrator, and
the distance L1 between the supersonic vibrator and the waterproof sheet is set to have a following value based on a wavelength L0 of the supersonic wave that is generated by the supersonic vibrator, wherein “n” is defined as an odd number,
L1=L0×n/4±1/4.

2. The vehicle warning apparatus of claim 1, wherein
the supersonic speaker includes a louver, the louver has a plurality of narrow boards that are arranged in parallel with a gap interposed therebetween,
the louver is disposed on the other side of the waterproof sheet such that the waterproof sheet is between the louver and the supersonic vibrator, and
a distance L2 between the waterproof sheet and an edge of the louver is set to have a following value based on the wavelength L0 of the supersonic wave, wherein “n” is defined as an odd number
L2=L0×n/4±1/4.

3. The vehicle warning apparatus of claim 1, wherein
the distance L1 is set to a minimum value that does not let the waterproof sheet contact the supersonic vibrator even when the waterproof sheet is deformed by a wind pressure due to a travel of the vehicle.

4. The vehicle warning apparatus of claim 1, wherein
the supersonic speaker defines a drain hole outside of the waterproof sheet at a lower part of the supersonic speaker.

5. The vehicle warning apparatus of claim 4, wherein
the drain hole has a cover that is disposed under a lower end of the drain hole with a predetermined gap interposed between the lower end of the drain hole and the cover.
